(19) United States
(12) Patent Application Publication
(10) Pub. No.: US 2005/0208295 A1
(43) Pub. Date: Sep. 22, 2005

(54) Adhesive sheet and kit for microbial testing of solid surface

(75) Inventors: Takeshi Saika, Osaka (JP); Koji Maruyama, Osaka (JP); Yasunobu Tanaka, Osaka (JP); Naohiro Noda, Kanagawa (JP); Takuya Onodera, Kanagawa (JP); Masao Nasu, Osaka (JP); Nobuyasu Yamaguchi, Osaka (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: FUJI ELECTRIC SYSTEMS CO, LTD, Tokyo (JP)

(21) Appl. No.: 10/526,794

(22) PCT Filed: Sep. 3, 2003
(86) PCT No.: PCT/JP03/11236

§ 371 Date: Jun. 3, 2005

(51) Int. Cl. B32B 7/12; B32B 15/04

(52) U.S. Cl. 428/343; 428/354

(57) ABSTRACT

The present invention provides an adhesive sheet and a kit for microbial testing, which enable monitoring of the presence of a microorganism and/or the cell count thereof on a solid surface conveniently on a real time basis, and which accommodate to automated focusing during image analysis. The present invention relates to an adhesive sheet for microbial testing having at least a substrate and an adhesive layer, which adhesive layer is compression-bonded to, and peeled from, the surface of a test article to collect microorganisms, and the surface of the adhesive layer is then subjected to image analysis, wherein a marker for focusing the image is provided in the substrate, or in the adhesive layer, or on the surface thereof.

### TECHNICAL FIELD

The present invention relates to an adhesive sheet for microbial testing. In more detail, the present invention relates to an adhesive sheet for microbial testing, which comprises at least a substrate and an adhesive layer, and also a focusing marker for collecting a microorganism using the adhesive layer and analyzing an image of the collected microorganism.

### BACKGROUND ART

To date, to detect and count microorganisms such as bacteria that are present on a test surface but cannot be observed macroscopically, the cultivation method, that is, a method wherein a solid plate medium formed with agar and the like is put against the test surface to transfer the microorganisms on the test surface onto the agar plate medium, the microorganism is cultured as is on the plate medium in an optimal environment, and emerging colonies are identified and counted macroscopically or using a stereoscopic microscope and the like, has generally been utilized. As examples of this method, the agar stamp method using Food Stamp (manufactured by Nissui Pharmaceutical Co., Ltd.) and the like can be mentioned.

Also, the membrane filter method, which uses a membrane filter with microbial collection capability and the like, is a method wherein microorganisms are washed down while the test surface is thoroughly wiped using physiological saline, phosphate buffer solution and the like, this stock of washings is filtered through a membrane filter to collect the microorganisms on the membrane filter, thereafter the microorganisms and a liquid medium are brought into thorough contact with each other to allow the microorganisms to form colonies on the filter, and the colonies are counted. The membrane filter method can also be utilized as a method wherein microorganisms are detected without cultivation by bringing the microorganisms collected on the filter into contact with an appropriate staining solution, and counting the cells that have developed a color using a microscope and the like.

However, because the agar stamp method and the like can usually be used only once for a single test surface, there have sometimes been disadvantages in microbial collection efficiency such as collection efficiency variation depending on the water content ratio of the agar medium, and poor reproducibility. Also, as a common problem in the cultivation method, there has sometimes been a disadvantage in later ratings because contamination among microorganisms occurs and pure culture is impossible due to the interactions among the microorganisms on the medium. Additionally, the cultivation method of course has suffered a limitation of being applicable only to viable cells and has posed a problem of non-detection. Furthermore, because the cultivation method requires a cultivation time of 1 to 2 days or more, it has suffered a critical limitation of not allowing microbial monitoring on a real time basis.

In addition, the membrane filter method has been faulty in that although the test article can be filtered as is, provided that it is a liquid article such as an aqueous solution and the like, a great deal of labor is taken to collect microorganisms, including sampling with swab and preparation of a stock of washings in the case of a non-liquid test article. Furthermore, there has been another problem wherein collected matter other than microorganisms swells due to washing-down and filtration procedures and interferes with subsequent observation and counting.

Recently, a microbial testing method has been proposed wherein after microorganisms on a solid surface are compression-bonded to, and peeled from, the surface of the adhesive layer of an adhesive sheet to collect the microorganisms, the microorganisms on the solid surface are detected quickly and conveniently by bringing an aqueous solution containing one kind or more of color developing substance capable of staining microorganisms into contact with the surface of the adhesive layer, and observing and counting the stained cells (image analysis) (see, for example, Japanese Patent Unexamined Publication No. 2002-142797). However, these are image analyses using a manually focusing microscope and the like, and focusing is often painstaking due to the shallow depth of field under high magnification use conditions; there has been a demand for automated focusing and automated analysis.

Accordingly, an object of the present invention is to provide an adhesive sheet and a kit for microbial testing, which make it possible to monitor the presence of microorganisms on a solid surface and/or the number of cells thereof conveniently on a real time basis, and which accommodate to automated focusing during image analysis.

### DISCLOSURE OF THE INVENTION

The present inventors diligently conducted investigations with the aim of accomplishing the above-described objects and, as a result, succeeded in conferring an automated focusing property to an adhesive sheet for microbial testing that comprises at least a substrate and an adhesive layer, wherein an image of the surface of the adhesive layer is analyzed after the adhesive layer is compression-bonded to, and peeled from, the surface of a test article to collect microorganisms, by providing a marker for focusing the image in the substrate, or in the adhesive layer, or on the surface thereof, and completed the present invention.

That is, the present invention relates to:

(1) an adhesive sheet for microbial testing, which comprises at least a substrate and an adhesive layer, which adhesive layer is compression-bonded to, and peeled from, the surface of a test article to collect microorganisms, and the surface of which is then subjected to image analysis, wherein a marker for focusing the image (focusing marker) is provided in the substrate, or in the adhesive layer, or on the surface thereof,

(2) the adhesive sheet for microbial testing of (1) above, wherein the substrate and/or the adhesive layer are/is a multilayer including a layer comprising a focusing marker,

(3) the adhesive sheet for microbial testing of (1) or (2) above, wherein the focusing marker is an insoluble particle with an average particle size of 0.2 to 200 μm,

(4) the adhesive sheet for microbial testing of (3) above, wherein the focusing marker is an insoluble particle with an average particle size of 0.5 to 200 μm,

(5) the adhesive sheet for microbial testing of (1) above, wherein the focusing marker on the substrate surface is an undulation pattern of 0.1 to 20 μm depth or a printed pattern with a color variation in the image used for focusing,

(6) the adhesive sheet of any of (1) to (5) above, wherein the smoothness (difference between concave and convex) of the surface of the adhesive layer of the adhesive sheet for microbial testing is smaller than the depth of the field of the optical system,

(7) a kit for microbial testing, which comprises an aqueous solution comprising one or more kinds of color developing substances capable of staining a microorganism and the adhesive sheet for microbial testing of any of (1) to (6) above,

(8) the kit of (7) above, wherein the color-developing substance is a fluorescent material, and the like.

That is, by once focusing the focal point of a microscope or optical equipment on an insoluble particle in the substrate, or in the adhesive layer, or in the surface thereof, or on an undulation pattern on the substrate surface, and, while immobilizing one of the adhesive sheet retainer or the optical system, moving the other in a specified distance, it is possible to obtain an image of a collected microorganism and conduct image analysis. Also, provided that the focal length difference between the marker and the collected microorganism is short, lens barrel movement after marker focusing is obviated.

The adhesive sheet for microbial testing of the present invention contains a focusing marker and has enabled automated focusing of optical equipment on an image of microorganisms collected on the surface of the adhesive layer of the adhesive sheet (hereinafter also referred to as “adhesive surface”). By analyzing color development number, color development condition or color development quantity using optical equipment with automated focusing function, it is possible to detect and/or count microorganisms such as bacteria, fungi and viruses quickly and conveniently on a real time basis.

The present invention also provides a kit for microbial testing suitable for conveniently and quickly performing microbial testing. Accordingly, another embodiment of the present invention is an adhesive sheet for microbial testing having a focusing marker and a kit for microbial testing comprising an aqueous solution containing one kind or more of a color-developing substance capable of staining a microorganism.

### MODES OF EMBODIMENT OF THE INVENTION

The adhesive sheet for microbial testing of the present invention has a structure wherein an adhesive layer based on a high-molecular compound is laminated on a substrate, and is provided with a layer of insoluble particles arranged in the substrate, or in the adhesive layer, or on the surface thereof, or with an undulation pattern arranged on substrate surface. The adhesive layer is a layer having sufficient adhesion to collect microorganisms on a test surface, and also having a smooth surface structure wherein the adhesive agent does not dissolve even in case of immersion in an aqueous solution for microbial staining, and may be provided with a layer of insoluble particles as a focusing marker on the substrate side of the adhesive layer, or on the microbial collection side, or in the adhesive layer. As examples of the insoluble particles, particles of calcium carbonate powder, titanium oxide powder, alumina powder, carbon black, silica powder, polystyrene powder, talc powder, asbestos powder, mica powder, clay powder, cellulose powder, starch and the like can be mentioned, and those with an average particle size of 0.2 to 200 μm can preferably be used. More preferably, those with an average particle size of 0.5 to 200 μm are used. Note that in the present specification, particle size is measured using a particle size distribution measuring apparatus of the laser diffraction/scattering type (manufactured by Horiba, Ltd.).

Although the adhesive agent of the adhesive layer is not subject to limitation, as long as it has adhesion enabling the collection of microorganisms on a test surface and does not dissolve in the aqueous solution during microbial staining, a non-water-soluble adhesive agent is preferred because the collected microorganisms and cells are unlikely to move. As examples of the non-water-soluble adhesive agent, an acrylic adhesive agent, a rubber-based adhesive agent, a silicone-based adhesive agent and the like can be used; from the viewpoint of small influence on the optical properties at the time of obtainment of fluorescent images, an acrylic adhesive agent or a silicone-based adhesive agent, which offer higher transparency of the adhesive layer, is preferred.

As the acrylic adhesive agent, copolymers prepared by copolymerizing a (meth)acrylic acid alkyl ester such as ethyl (meth)acrylate, propyl (meth)acrylate, butyl (meth)acrylate, hexyl (meth)acrylate, octyl (meth)acrylate, nonyl (meth)acrylate, or decyl (meth)acrylate, as the primary component monomer, with one kind or two kinds or more of a hydrophilic monomer like (meth)acrylic acid, itaconic acid, aleic acid, hydroxyethyl (meth)acrylate, methoxyethyl (meth)acrylate, ethoxyethyl (meth)acrylate, butoxyethyl (meth)acrylate, and ethyleneglycol (meth)acrylate, can be mentioned. Furthermore, to improve the adhesive characteristic thereof, such an adhesive layer is preferably crosslinked by conducting a treatment with a thermal crosslinking agent like an isocyanate compound, an organic peroxide, an epoxy-group-containing compound, and a metal chelate compound, or a treatment with ultraviolet rays, gamma rays, electron rays and the like.

As the rubber-based adhesive agent, a blend of natural rubber, polyisobutyrene, polyisoprene, polybutene, a styrene-isoprene-series block copolymer, a styrene-butadiene-series block copolymer and the like, as the primary polymer, with a rosin-series resin, a terpene-series resin, a chroman-indene-series resin, a terpene-phenol-series resin, a petroleum-series resin and the like, as the adhesion-conferring resin, can be used. As examples of the silicone-based adhesive agent, adhesive agents based on dimethylpolysiloxane can be mentioned.

Also, in counting the collected microorganisms using a microscope, optical equipment and the like, to finally focus on the microorganisms collected on the adhesive layer surface, the smoothness (difference between concave and convex) of the surface is preferably smaller than the depth of field of the optical system. This is because the microorganisms can be counted exhaustively, provided that the smoothness is smaller than the depth of field of the optical system. The smoothness can be determined by observing a cross-section of the adhesive sheet for microbial testing using a surface roughness tester or an electron microscope and the like, and measuring the altitude difference between the apex of the convex of the adhesive layer surface and the lowermost point of the concave.

The substrate of the adhesive sheet for microbial testing is not subject to limitation, as long as it is a material that is non-water-soluble, does not allow formation of large irregularities on the adhesive layer surface, and is flexible to the extent that permits free compression bonding even to a curved surface or a narrow surface, and polyester, polyethylene, polyurethane, vinyl chloride, cloth, nonwoven fabric, paper, polyethylene laminate paper and the like can be mentioned as examples. In particular, smooth polyester, polyethylene, vinyl chloride, and polyurethane are desirable as the substrate. The thickness of the substrate is not subject to limitation, as long as the substrate is sufficiently tough as a support, and is preferably about 5 to 200 μm.

The substrate of the adhesive sheet for microbial testing may be provided with a focusing marker. The position of the focusing marker can be chosen from among three sites as with the adhesive layer, that is, on the adhesive layer side, on the side opposite thereto, and in the substrate. As the method of conferring a focusing marker to the substrate, a method wherein extrusion or casting is conducted on an uneven surface of the substrate during film making; a method wherein the surface of the film of the substrate is flawed by sandblasting treatment and the like, a method wherein a print is made on the substrate surface, a method wherein a layer containing a focusing marker including insoluble particles is laminated on the substrate, and the like can be mentioned. When an undulation pattern is provided on the surface of the film of the substrate by extrusion or casting on an uneven surface of the substrate during film making, or by sandblasting treatment and the like, the preferable depth of the undulation pattern is about 0.1 to 20 μm. The focusing marker conferred by printing is preferably printed not by allover painting, but in a pattern of lines, lattices, dots and the like, and more preferably has a color variation in the image used for focusing. When a layer containing a focusing marker including insoluble particles is laminated on the substrate, the insoluble particles may be the same as those in the above-described case of the adhesive layer. Bubbles of air, carbonic acid gas and the like can also be used in place of these insoluble particles. Also, a protective substrate layer not containing a focusing marker can also be further laminated.

Also, conferring a focusing marker in the substrate can be performed by blending the resin for making a film of the substrate with insoluble particles, and preparing the film. As examples of the insoluble particles, like in the case of the adhesive layer, particles of calcium carbonate powder, titanium oxide powder, alumina powder, carbon black, silica powder, polystyrene powder, talc powder, asbestos powder, mica powder, clay powder, cellulose powder, starch and the like can be mentioned, and those having an average particle size of 0.2 to 200 μm are preferably used. More preferably, those with an average particle size of 0.5 to 200 μm are used. Bubbles of air, carbonic acid gas and the like can also be used in place of these insoluble particles.

These focusing markers can be arranged in the substrate of the adhesive sheet for microbial testing, or in the adhesive layer, or on the surface thereof, and these modes may be concurrent.

The adhesive sheet for microbial testing of the present invention is produced using a method known per se. For example, the adhesive sheet for microbial testing of the present invention is produced by applying a solution containing a high-molecular compound used in the adhesive layer to a substrate such as a film, and drying it at room temperature to 200° C. In addition, methods such as calendering, casting and extrusion molding can also be used.

When a focusing marker is conferred to the substrate, the above-described surface processing treatment is conducted, or insoluble particles are added and a film of the substrate is made, or a resin having insoluble particles added thereto is laminated using a method such as application, calendering, casting, or extrusion molding and, if necessary, a resin not having insoluble particles added thereto is overlain in the same manner; it is preferable to confer the focusing marker to the substrate before the adhesive layer is laminated.

(1) Conferring a focusing marker into the adhesive layer can be achieved by previously adding insoluble particles to a solution containing a high-molecular compound used in the adhesive layer,

(2) conferring a focusing marker onto the microbial collection side surface of the adhesive layer can be achieved by laminating the adhesive layer on the substrate, and thereafter adding insoluble particles, and (3) conferring a focusing marker onto the substrate side surface of the adhesive layer can be achieved by adding insoluble particles to the adhesive layer surface laminated previously on release paper, and thereafter laminating the adhesive layer on the substrate. Furthermore, conferring a focusing marker can also be achieved by alternatively laminating on the substrate a solution containing a high-molecular compound having insoluble particles added thereto, which is to be the layer containing the focusing marker, and a solution containing the high-molecular compound not having insoluble particles added thereto, using a method described above, such as application or extrusion. If direct lamination is impossible, it is possible to achieve lamination by previously laminating the adhesive layer on release paper, and thereafter conducting transfer. The thus-obtained sheet can be used as cut into an optionally chosen shape.

In the present invention, by irradiating the adhesive sheet for microbial testing with a radiation such as electron rays or gamma rays, it is also possible to crosslink the high-molecular compound used in the adhesive layer, simultaneously with sterilization. Also, sterilization can also be achieved using a gas such as ethylene oxide. Furthermore, by containing the adhesive sheet for microbial testing in a microorganism-blocking packaging material while in a sterilized state, and the like, a sterile state can be retained.

Microorganisms that are subjects of testing according to the present invention include prokaryotic organisms such as bacteria and actinomyces, eukaryotic organisms such as yeast and fungi, lower algae, viruses, cultured animal and plant cells and the like.

The present invention also provides a kit for microbial testing. The kit for microbial testing of the present invention comprises an adhesive sheet for microbial testing having a focusing marker as described above and an aqueous solution containing one kind or more of a color-developing substance capable of staining microorganisms. The color-developing substance is not subject to limitation, as long as it acts on a cellular component contained in the microorganism that is the subject of testing to develop a color; as a representative example thereof, a fluorescent staining solution that stains nucleic acid or protein can be mentioned. As more specific color-developing dyes, a fluorescent nucleic acid base analogue, a fluorescent staining agent that stains nucleic acid, a staining solution that stains protein, an environmental fluorescent probe used for structural analysis of protein and the like, a staining solution used for analysis of cell membrane or membrane potential, a staining solution used for labeling of fluorescent antibody and the like when the test subject is general microorganisms; a staining solution that develops a color in response to cell respiration and the like when the test subject is aerobic bacteria; a staining solution that stains mitochondria, a staining solution that stains Golgi apparatus, a staining solution that stains endoplasmic reticulum, a staining solution that reacts with intracellular esterase and a modified compound thereof and the like when the test subject is eukaryotic organisms; and a staining solution used for examination of bone tissue, a staining solution that is a nerve cell tracer and the like when the test subject is higher animal cells, can be mentioned, and these can be observed using a fluorescence microscope.

By choosing a kind of these color developing substances, the present invention is applicable to a broad range of fields, including total microbial counting, which counts all microorganisms; a test wherein only microorganisms with respiratory activity are stained and counted; a test wherein only microorganisms with esterase activity are stained and counted; a test wherein microorganisms of a particular genus or species are stained and counted using the double staining method, which combines a plurality of color-developing substances, and the like.

The adhesive sheet for microbial testing is compression-bonded to a test surface of a floor, a wall and the like to efficiently transfer, and prepare a stock of, microorganisms adhering on the test surface. When a test surface considered to have a relatively small number of microorganisms is compression-bonded, the test surface may be compression-bonded to the same surface of the adhesive sheet a plurality of times. Because the method of the present invention does not require cultivation as does the agar stamp method, there is no concern about colony contamination, nor is there any apprehension about changes in fungal phases during cultivation, microorganisms can be collected multiply. Therefore, by increasing compression bonding frequency, a large number of microorganisms can be collected as with filtration and concentration of water-dispersed microorganisms in the membrane filter method.

Next, the adhesive sheet that has collected microorganisms is cut into a specified size as necessary, and the surface on which the microorganisms have been collected is immersed in an aqueous solution containing a color-developing substance to stain the microorganisms. If it is necessary to remove an excess of the color-developing substance, the surface on which the microorganisms have been collected is washed by rinsing with sterile water and the like. Also, if it is necessary to dry the surface on which a stock of microorganisms has been prepared after staining the microorganisms, the surface can be dried by air drying, spontaneous drying, reduced-pressure drying and the like. Microbial detection or counting can be conducted by forming an optical image using an optical microscope, a fluorescence microscope, a laser microscope, a laser scanning cytometer or other appropriate optical equipment, and analyzing this image. In this operation, using optical equipment with automated focusing function or automated analysis function allows the adhesive sheet for microbial testing of the present invention to exhibit its performance in full to enable quick image analysis. Also, because of obviation of cultivation procedures, the microorganisms on the adhesive surface of the adhesive sheet can substantially be detected within several minutes to ten and several minutes.

As an example application of the present invention, it is possible to apply the adhesive surface to the test surface to transfer the microorganisms that are present on the test surface, to stain the microorganisms without preculture, and to observe the microorganisms as is in the form of single cells, so that the present invention can be utilized for environmental surveys and the like wherein the cleanliness of the test article is determined quickly. Furthermore, because of recovery at a single-cell level, it is also possible and practical to compression-bond the adhesive sheet to the test surface a plurality of times to collect and concentrate microorganisms. As fields of its applications, the present invention can be applied to environmental microbial testing and the like in actual settings of medical practice, food production and the like.

### EXAMPLES

The present invention is hereinafter described more specifically by means of the following Examples and Comparative Examples, which examples, however, are given only for the sake of exemplification and are not to be construed as limiting the scope of the present invention.

### Example 1

1) Preparation of adhesive sheet for microbial testing

Isononyl acrylate/2-methoxyethyl acrylate/acrylic acid (65/30/5 (charge ratio by weight)) was polymerized with azoisobutyronitrile as the polymerization initiator to yield a copolymer solution in toluene with a gel fraction ratio of 40 w/w %. A volume of calcium carbonate powder (average particle size 4 μm) or cellulose powder (average particle size 10 μm) equivalent to 0.4 w/w % of the copolymer solution was added to the copolymer solution, and the solution was vigorously stirred, after which the solution was applied to a transparent polyester of 50 μm thickness so that the coating thickness upon drying would be 20 μm, and dried at 130° C. for 5 minutes. Furthermore, gamma ray sterilization at a dose of 25 k gray was conducted.

2) Microbial collection and staining

0.1 mL of an Escherichia coli K-12 culture broth diluted 100 fold with sterile water was filtered through a polycarbonate membrane with 0.4 μm straight pores; using the microorganism on the flat membrane washed with sterile phosphate buffer solution as the sample, the adhesive sheet for microbial testing prepared in 1) was pressed against the filtration surface and then peeled. Next, a phosphate buffer solution containing 0.1% of 6-carboxyfluorescein diacetate, as the staining solution, was added drop by drop to the surface on which the microorganism had been collected, and the adhesive sheet for microbial testing was kept to stand at room temperature for 3 minutes to achieve staining, after which the microbial collection surface was washed with phosphate buffer solution.

3) Counting

Optical equipment capable of controlling a stepping motor using a personal computer to drive either an optical system or an adhesive sheet retainer on 1 μm accuracy on the basis of image information obtained using an optical system equipped with a CCD camera at a magnifying power of 10 to 40 times (hereinafter referred to as “measuring apparatus”) was provided, and microbial counts were taken on the microbial collection surface of the adhesive sheet for microbial testing with the collected microorganism stained. Specifically, either the lens barrel or the adhesive sheet was moved in the vicinity of the adhesive surface, and the focal point position at which a focusing marker such as calcium carbonate powder produced an image was memorized; after the lens barrel or the adhesive sheet was further moved therefrom in a specified distance to the position at which the adhesive layer surface was in focus (quantity depending on the distance between focusing marker and microbial adherence surface), excitation was conducted with light of 490 nm main wavelength, and the number of stained cells obtained as green bright points was processed using image analysis software to determine the cell count for one visual field; the stage on which the adhesive sheet for microbial testing was immobilized was electrically controlled, and counts were taken for other visual fields in the same manner; the counts for a total of 70 visual fields were averaged. Also, with a sterile solution as the sample in place of the diluted culture broth, counts were taken in the same manner for the adhesive surface of an adhesive sheet for microbial testing to which no microorganisms had been collected.

### Comparative Example 1

An adhesive sheet for microbial testing was prepared in the same manner as Example 1, except that insoluble particles of calcium carbonate powder and the like were not added to the adhesive layer, and microbial collection, staining, and counting were also conducted in the same manner as Example 1. The results of Example 1 and Comparative Example 1 are shown in Table 1.

TABLE 1

| Focusing | | | | |
|---|---|---|---|---|
| marker | | | | |
| (contained in | Test | | Cell | |
| adhesive | micro- | Number of cells | recovery | |
| layer) | organism | counted (/mm²) | rate (%) | Remarks |
| Calcium | Escherichia | 2643 | 76.0 | Example |
| carbonate | coli K-12 | | | 1 |
| powder | None | 22 | <1 | Example |
| | | | | 1 |
| Cellulose | Escherichia | 2832 | 81.4 | Example |
| powder | coli K-12 | | | 1 |
| | None | 18 | <1 | Example |
| | | | | 1 |
| None | Escherichia | 233 | 6.7 | Comparative |
| | coli K-12 | | | Example |
| | | | | 1 |
| | None | Counting | — | Comparative |
| | | impossible | | Example |
| | | (focusing | | 1 |
| | | failed) 1 | | |

As shown in Table 1, in Example 1, automated focusing function was enabled on the focusing marker of the adhesive sheet for microbial testing, and Escherichia coli K-12 counts could be taken. The detection of a few microorganisms even with the adhesive sheet for microbial testing that had collected no microorganisms is attributable to the entry of microorganisms or fluorescent particle noise from the measuring environment and the like. In Comparative Example 1, due to the lack of a focusing marker, focusing failed and counting was impossible. Regarding the reason why cell counting was possible even in the absence of a focusing marker when Escherichia coli K-12 was collected, it can be considered that the number of bright points on the image decreased because a shift occurred in a specified distance (quantity depending on the distance between focusing marker and microbial adherence surface) as the collected microorganism was recognized as the focusing marker. When no focusing marker is provided in the adhesive sheet like this, it is possible to directly focus on the surface on which microorganisms have been collected, provided that the number of microorganisms collected is large, but this is imperfect for a counting system because direct focusing is impossible with a small number of microorganisms collected.

### Example 2

The copolymer solution in toluene obtained in Example 1, without adding insoluble particles thereto, was applied to (1) a transparent polyester film of 25 μm thickness having a non-adhesive surface scratched to a depth of about 1 μm using #1200 sandpaper and (2) a polyester film of 26 μm thickness mixed with a silica powder with an average particle size of 5 μm, so that the coating thickness upon drying would be 20 μm, and the films were dried at 130° C. for 5 minutes. Furthermore, gamma ray sterilization at a dose of 25 k gray was conducted to yield adhesive sheets for microbial testing. Next, microbial collection, staining, and washing were conducted in the same manner as Example 1, except that 0.1 mL of a staphylococcus culture broth diluted 10 fold with sterile water was filtered through a polycarbonate membrane having 0.4 μm straight pores, and that the microorganism on a flat membrane washed with sterile phosphate buffer solution was used as the sample. Counting was conducted in the same manner as Example 1.

### Comparative Example 2

An adhesive sheet for microbial testing was prepared in the same manner as Example 2, except that the substrate was an untreated transparent polyester film of 25 μm thickness, and microbial collection, staining, washing, and counting were conducted. The results of Example 2 and Comparative Example 2 are shown in Table 2.

TABLE 2

| | Test | Number of | Cell | |
|---|---|---|---|---|
| Focusing | micro- | cells counted | recovery | |
| marker | organism | (/mm²) | rate (%) | Remarks |
| Silica powder | Staphylococcus | 3149 | 104.0 | Example 2 |
| (contained in | None | 29 | <1 | Example 2 |
| substrate) | | | | |
| Substrate | Staphylococcus | 2832 | 93.5 | Example 2 |
| surface | None | 12 | <1 | Example 2 |
| sandpaper | | | | |
| treatment | | | | |
| None | Staphylococcus | 0 | 0 | Comparative |
| | | | | Example 2 |
| | None | Counting | — | Comparative |
| | | impossible | | Example 2 |
| | | (focusing | | |
| | | failed) | | |

As shown in Table 2, in Example 2 as well, the automated focusing function of the measuring apparatus was enabled on the focusing marker of the adhesive sheet for microbial testing, and staphylococcus counts could be taken. However, in Comparative Example 2, due to the lack of a focusing marker, focusing failed and counting was impossible. However, when a staphylococcus was collected, the image taken had no bright points because the collected microorganism was recognized as the focusing marker, and because a shift occurred in a specified distance (quantity depending on the distance between focusing marker and microbial adherence surface); the number of cells counted was 0.

### Example 3

1) Preparation of adhesive sheet for microbial testing

Isononyl acrylate/2-methoxyethyl acrylate/acrylic acid (65/30/5 (charge ratio by weight)) was polymerized with azoisobutyronitrile as the polymerization initiator to yield a copolymer solution in toluene with a gel fraction ratio of 40 w/w %. A volume of alumina powder (average particle size 0.5 μm), calcium carbonate powder (average particle size 4 μm), titanium oxide powder (average particle size 0.2 μm) or cellulose powder (average particle size 6 μm), as the focusing marker, equivalent to 4 w/w % of the copolymer solution, was added to the copolymer solution, and the solution was vigorously stirred, after which the solution was applied to a peelable polyester film of 75 μm thickness so that the coating thickness upon drying would be 10 μm, and the film was dried at 130° C. for 5 minutes. The thus-obtained adhesive layer containing the focusing marker was transferred onto a transparent polycarbonate substrate of 33 μm thickness. Furthermore, an adhesive layer of 10 μm thickness prepared in the same manner using a copolymer solution not containing the focusing marker was laminated on the adhesive layer containing the focusing marker. Subsequently, gamma ray sterilization at a dose of 25 k gray was conducted.

2) Microbial collection and staining

0.1 mL of an Escherichia coli K-12 culture broth diluted 100 fold with sterile physiological saline or 0.1 mL of a staphylococcus culture broth diluted 20 fold was filtered through a polycarbonate membrane having 0.4 μm straight pores; using the microorganism on the flat membrane washed with sterile phosphate buffer solution as the sample, the adhesive sheet for microbial testing prepared in 1) was pressed against the filtration surface and then peeled. Next, a phosphate buffer solution containing 0.1% of 6-carboxyfluorescein diacetate, as the staining solution, was added drop by drop to the surface on which the microorganism had been collected, and the adhesive sheet was kept to stand at room temperature for 3 minutes to achieve staining, after which the microbial collection surface was washed with phosphate buffer solution.

3) Counting

The same measuring apparatus as Example 1 was provided, and microbial counts were taken on the microbial collection surface of the adhesive sheet for microbial testing with the collected microorganism stained. Specifically, the adhesive sheet retainer was moved in the vicinity of the adhesive surface, and the focal point position at which a focusing marker such as calcium carbonate powder produced an image was memorized; after the adhesive sheet retainer was further moved therefrom in a specified distance to the position at which the adhesive layer surface was in focus (quantity depending on the distance between the focusing marker, and the microbial adherence surface), excitation was conducted with light of 490 nm main wavelength and the number of stained cells obtained as green bright points was processed using image analysis software to determine the cell count for one visual field; the stage on which the adhesive sheet for microbial testing was immobilized was electrically controlled, and counts were taken for other visual fields in the same manner; the counts for a total of 70 visual fields were averaged. Also, with sterile physiological saline as the sample in place of the diluted culture broth, counts were taken in the same manner for the adhesive surface of an adhesive sheet for microbial testing to which no microorganisms had been collected.

### Comparative Example 3

An adhesive sheet for microbial testing was prepared in the same manner as Example 3, except that insoluble particles of calcium carbonate powder and the like were not added to the central adhesive layer, and microbial collection, staining, and counting were also conducted in the same manner as Example 3. The results of Example 3 and Comparative Example 3 are shown in Table 3.

TABLE 3

| | | Number of | Cell | |
|---|---|---|---|---|
| Focusing | Test | cells | recovery | |
| marker | microorganism | counted (/mm²) | rate (%) | Remarks |
| Alumina | Escherichia coli | 2884 | 72 | Example 3 |
| powder | K-12 | | | |
| | Staphylococcus | 2383 | 95 | Example 3 |
| | None | 12 | — | Example 3 |
| Calcium | Escherichia coli | 3496 | 87 | Example 3 |
| carbonate | K-12 | | | |
| powder | Staphylococcus | 2525 | 101 | Example 3 |
| | None | 6 | — | Example 3 |
| Titanium | Escherichia coli | 3092 | 77 | Example 3 |
| oxide | K-12 | | | |
| powder | Staphylococcus | 2360 | 94 | Example 3 |
| | None | 9 | — | Example 3 |
| Cellulose | Escherichia coli | 3260 | 81 | Example 3 |
| powder | K-12 | | | |
| | Staphylococcus | 2368 | 95 | Example 3 |
| | None | 3 | — | Example 3 |
| None | Escherichia coli | 44 | 1 | Comparative |
| | K-12 | | | Example 3 |
| | Staphylococcus | 36 | <1 | Comparative |
| | | | | Example 3 |
| | None | Counting | — | Comparative |
| | | impossible | | Example 3 |
| | | (focusing | | |
| | | failed) | | |

As shown in Table 3, in Example 3, automated focusing function was enabled by the focusing marker of the adhesive sheet for microbial testing, and Escherichia coli K-12 or staphylococcus counts could be taken. The detection of a few microorganisms even with the adhesive sheet for microbial testing that had collected no microorganisms is attributable to the entry of microorganisms or fluorescent particle noise from the measuring environment and the like. In Comparative Example 3, due to the lack of a focusing marker, focusing failed and counting was impossible. Regarding the reason why a few cells were countable even in the absence of a focusing marker when the microorganism Escherichia coli K-12 or staphylococcus was used as the test microorganism, it can be considered that the number of bright points on the image decreased because the focal point shifted in a specified distance (quantity depending on the distance between focusing marker and microbial adherence surface) as the collected microorganism or foreign matter is sometimes recognized as the focusing marker at the time of microbial collection. When no focusing marker is provided in the adhesive sheet like this, it is possible to directly focus on the surface on which microorganisms have been collected, provided that the number of microorganisms collected is large, but this is imperfect for a counting system because direct focusing is impossible with a small number of microorganisms collected.

### Example 4

One part by weight of a saturated polyester with an average molecular weight of 20000 was dissolved in 3.5 parts by weight of methylene chloride, and 0.1 part by weight of calcium carbonate powder (average particle size 2 μm) was added and dispersed. This solution was applied to a transparent polyester film of 50 μm thickness so that the coating thickness upon drying would be 10 μm, and the film was dried at 80° C. for 5 minutes to yield a substrate having a focusing marker on one surface. To prepare the adhesive agent, 10 parts by weight of a styrene-isoprene copolymer (average molecular weight 200000, styrene unit 15%), 9 parts by weight of a polyisoprene (average molecular weight 29000), and 12 parts by weight of a terpene copolymer (average molecular weight 1350) were dissolved in 22 parts by weight of toluene, and this solution was applied to a peelable polyester film of 75 μm thickness so that the coating thickness upon drying would be 20 μm, and the film was dried at 130° C. for 5 minutes. The thus-obtained adhesive layer was transferred to the marker side surface or non-marker side surface of the substrate having the focusing marker. Furthermore, gamma ray sterilization at a dose of 25 k gray was conducted to yield an adhesive sheet for microbial testing. Next, using a staphylococcus culture broth, microbial collection, staining, washing, and counting were conducted in the same manner as Example 1.

### Comparative Example 4

An adhesive sheet for microbial testing was prepared in the same manner as Example 4, except that a focusing marker was not added to the substrate, and microbial collection, staining, washing, and counting were conducted. The results of Example 4 and Comparative Example 4 are shown in Table 4.

TABLE 4

| Focusing | | Number | | |
|---|---|---|---|---|
| marker | | of cells | Cell | |
| position in | Test | counted | recovery | |
| substrate | microorganism | (/mm²) | rate (%) | Remarks |
| Adhesive layer | Staphylococcus | 2357 | 94 | Example 4 |
| side | None | 15 | — | Example 4 |
| Non-adhesive | Staphylococcus | 2222 | 89 | Example 4 |
| layer side | None | 2 | — | Example 4 |
| None | Staphylococcus | 1 | <1 | Comparative |
| | | | | Example 4 |
| | None | Counting | — | Comparative |
| | | impossible | | Example 4 |
| | | (focusing | | |
| | | failed) | | |

As shown in Table 4, in Example 4 as well, irrespective of focusing marker position, the automated focusing function of the measuring apparatus was effected on the focusing marker of the adhesive sheet for microbial testing, and staphylococcus counts could be taken. However, in Comparative Example 4, due to the lack of a focusing marker, focusing failed and counting was impossible. Regarding the reason why cells were countable even in the absence of a focusing marker when staphylococcus was used as the test microorganism, it can be considered that the number of bright points on the image decreased because the focal point shifted in a specified distance (quantity depending on the distance between focusing marker and microbial adherence surface) as the collected staphylococcus or foreign matter is sometimes recognized as the focusing marker.

### INDUSTRIAL APPLICABILITY

The adhesive sheet for microbial testing of the present invention contains a focusing marker, and has enabled automated focusing of optical equipment on an image of microorganisms collected on the adhesive surface. By analyzing color development number, color development condition or color development quantity using optical equipment with automated focusing function, it is possible to detect and/or count microorganisms such as bacteria, fungi, and viruses quickly and conveniently on a real time basis.

This application is based on a patent application No. 260468/2002 filed in Japan, the contents of which are hereby incorporated by reference.

1. An adhesive sheet for microbial testing, which comprises at least a substrate and an adhesive layer, which adhesive layer is compression-bonded to, and peeled from, the surface of a test article to collect microorganisms, and the surface of which is then subjected to image analysis, wherein a marker for focusing the image (focusing marker) is provided in the substrate, or in the adhesive layer, or on the surface thereof.

2. The adhesive sheet for microbial testing of claim 1, wherein the substrate and/or the adhesive layer are/is a multilayer including a layer comprising a focusing marker.

3. The adhesive sheet for microbial testing of claim 1, wherein the focusing marker is an insoluble particle with an average particle size of 0.2 to 200 μm.

4. The adhesive sheet for microbial testing of claim 2, wherein the focusing marker is an insoluble particle with an average particle size of 0.2 to 200 μm.

5-8. (canceled)

9. The adhesive sheet for microbial testing of claim 1, wherein the focusing marker is an insoluble particle with an average particle size of 0.5 to 200 μm.

10. The adhesive sheet for microbial testing of claim 2, wherein the focusing marker is an insoluble particle with an average particle size of 0.5 to 200 μm.

11. The adhesive sheet for microbial testing of claim 1, wherein the focusing marker on the substrate surface is an undulation pattern of 0.1 to 20 μm depth or a printed pattern with a color variation in the image used for focusing.

12. The adhesive sheet of claim 1, wherein the smoothness (difference between concave and convex) of the surface of the adhesive layer of the adhesive sheet for microbial testing is smaller than the depth of the field of the optical system.

13. The adhesive sheet of claim 2, wherein the smoothness (difference between concave and convex) of the surface of the adhesive layer of the adhesive sheet for microbial testing is smaller than the depth of the field of the optical system.

14. The adhesive sheet of claim 3, wherein the smoothness (difference between concave and convex) of the surface of the adhesive layer of the adhesive sheet for microbial testing is smaller than the depth of the field of the optical system.

15. The adhesive sheet of claim 4, wherein the smoothness (difference between concave and convex) of the surface of the adhesive layer of the adhesive sheet for microbial testing is smaller than the depth of the field of the optical system.

16. The adhesive sheet of claim 9, wherein the smoothness (difference between concave and convex) of the surface of the adhesive layer of the adhesive sheet for microbial testing is smaller than the depth of the field of the optical system.

17. The adhesive sheet of claim 10, wherein the smoothness (difference between concave and convex) of the surface of the adhesive layer of the adhesive sheet for microbial testing is smaller than the depth of the field of the optical system.

18. The adhesive sheet of claim 11, wherein the smoothness (difference between concave and convex) of the surface of the adhesive layer of the adhesive sheet for microbial testing is smaller than the depth of the field of the optical system.

19. A kit for microbial testing, which comprises an aqueous solution comprising one or more kinds of color developing substances capable of staining a microorganism and an adhesive sheet for microbial testing, which comprises at least a substrate and an adhesive layer, which adhesive layer is compression-bonded to, and peeled from, the surface of a test article to collect microorganisms, and the surface of which is then subjected to image analysis, wherein a marker for focusing the image (focusing marker) is provided in the substrate, or in the adhesive layer, or on the surface thereof.

20. The kit of claim 19, wherein the color-developing substance is a fluorescent material.

21. The kit of claim 19, wherein the substrate and/or the adhesive layer are/is a multilayer including a layer comprising a focusing marker.

22. The kit of claim 21, wherein the focusing marker is an insoluble particle with an average particle size of 0.2 to 200 μm.

23. The kit of claim 19, wherein the focusing marker on the substrate surface is an undulation pattern of 0.1 to 20 μm depth or a printed pattern with a color variation in the image used for focusing.

24. The kit of claim 19, wherein the smoothness (difference between concave and convex) of the surface of the adhesive layer of the adhesive sheet for microbial testing is smaller than the depth of the field of the optical system.
